(19) United States
(12) Patent Application Publication
(10) Pub. No.: US 2008/0022569 A1
(43) Pub. Date: Jan. 31, 2008

(54) INFORMATIONAL CARTON WITH SOUND DEVICE

(76) Inventor: Brian J. Winn, Mill Creek, WA (US)

Correspondence Address: BLACK LOWE & GRAHAM, PLLC, 701 FIFTH AVENUE, SUITE 4800, SEATTLE, WA, 98104, US

(21) Appl. No.: 11/770,563

(22) Filed: Jun. 28, 2007

Related U.S. Application Data
(60) Provisional application No. 60/833,285, filed on Jul. 25, 2006.

(51) Int. Cl. G09F 27/00

(52) U.S. Cl. 40/457

(57) ABSTRACT

An informational carton with integrated circuitry to enable an audio advertisement for multiple items contained in the carton and displayed for sale. The carton preferably houses a sound card that is activated by pressing a button. Once activated, an audio message will play in order to inform the consumer about the product or service being offered. Printed graphics on the side of the carton attract attention to the button.

### PRIORITY CLAIM

This application claims the benefit of U.S. Provisional application Ser. No. 60/833,285, filed on Jul. 25, 2006.

### FIELD OF THE INVENTION

The present invention relates generally to packaging devices, particularly including packaging boxes or trays in that hold multiple items for sale.

### BACKGROUND OF THE INVENTION

In making purchasing decisions, consumers have limited information to evaluate. Product packaging and labels can provide a certain amount of information, but for products in small packages the ability to provide meaningful information is limited. In certain settings, large displays have incorporated a television set and recorded infomercial type programming that is played continuously. Consumers can watch the recording and listen to the information that may help them to make a purchasing decision.

This type of system is cumbersome, expensive, and not suitable for all locations. There is a need for an audio or visual informational device that can be incorporated directly into a display carton housing a plurality of items that are offered for sale. Such a system would be particularly useful in “big box” or warehouse type stores in which cartons holding many items are placed directly on the shelves, rather than removing the items from the carton and displaying them individually.

### SUMMARY OF THE INVENTION

In its preferred form, the present invention provides a new informational box or tray with an incorporated sound device having stored audio messages related to the products contained within the box or tray. The box or tray is particularly suitable for advertising multiple items in a display box or tray for a retail sale. The box or tray (or other form of multiple-unit packaging, which will be generically referred to as a “carton” within this description) which houses the sound device can be activated by the consumer pressing a button. Once activated, an audio message will play in order to inform or educate the consumer regarding the product or service being offered for sale. The vendor is thereby able to provide far more information to the potential consumer than packaging might allow, and to do so in a way that incorporates any manner of audio features.

### BRIEF DESCRIPTION OF THE DRAWINGS

Preferred and alternative embodiments of the present invention are described in detail below with reference to the following drawings:

FIG. 1 is a perspective view of a preferred carton having in incorporated sound device;

FIG. 2 is a top plan view of a preferred speaker, sound card, and switch;

FIG. 3 is a perspective view of a preferred carton in a partially disassembled form; and

FIG. 4 is a plan view of a preferred sound device incorporated onto a single printed circuit board.

### DETAILED DESCRIPTION OF THE PREFERRED EMBODIMENT

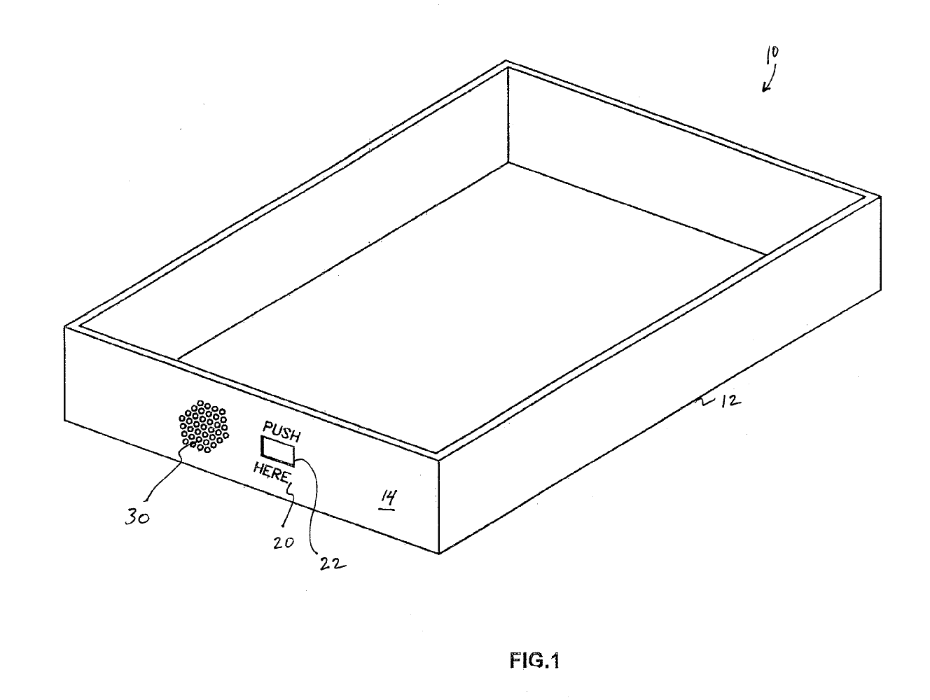

As illustrated in FIGS. 1-3, the preferred package 10 includes a carton 12 configured to hold a plurality of items for retail sale. In the example as shown, the carton 12 is in the form of a shallow cardboard tray that can be placed on a shelf within a store. Display cartons of this type are commonly found in warehouse type stores, especially those in which the carton 12 used for display is also the same carton (in whole or in part) that served as the shipping container for the goods on display. During shipping, the goods may be shrink-wrapped in place within the carton, such that the plastic shrink-wrap can be removed when the goods are placed on the shelf (while still within the carton) for display and consumer purchase. Alternatively, a portion of the box may be perforated to facilitate removal of a portion of the box from the bottom tray, leaving the lower tray or carton 12 so that it can be used to present the goods for purchase.

The particular goods are not illustrated in FIG. 1, but may be anything consumers might purchase. For example, the tray may hold a plurality of canned goods, bottled or canned beverages, packaged or boxed food items, or other consumables. It may also hold toys, electronics, or any other consumer item. Trays of the sort depicted in FIG. 1 are also frequently used to hold plastic containers, and often include a number of vertical slots to hold a plurality of such containers in place in a vertical alignment. Regardless of the particular orientation or type of goods within the carton, in the preferred example the invention includes such a carton 12 to house a plurality of goods being offered for sale.

As described, the preferred example of the invention includes a carton formed from cardboard. Alternatively, the carton may be formed from plastic, wood, metal, paper, or other material. Likewise, the shallow form of the carton as illustrated may be modified in a variety of ways. It may for example, be much deeper, need not be open at the top, may be asymmetrical with respect to the heights of the vertical walls, and may be other than square or rectangular.

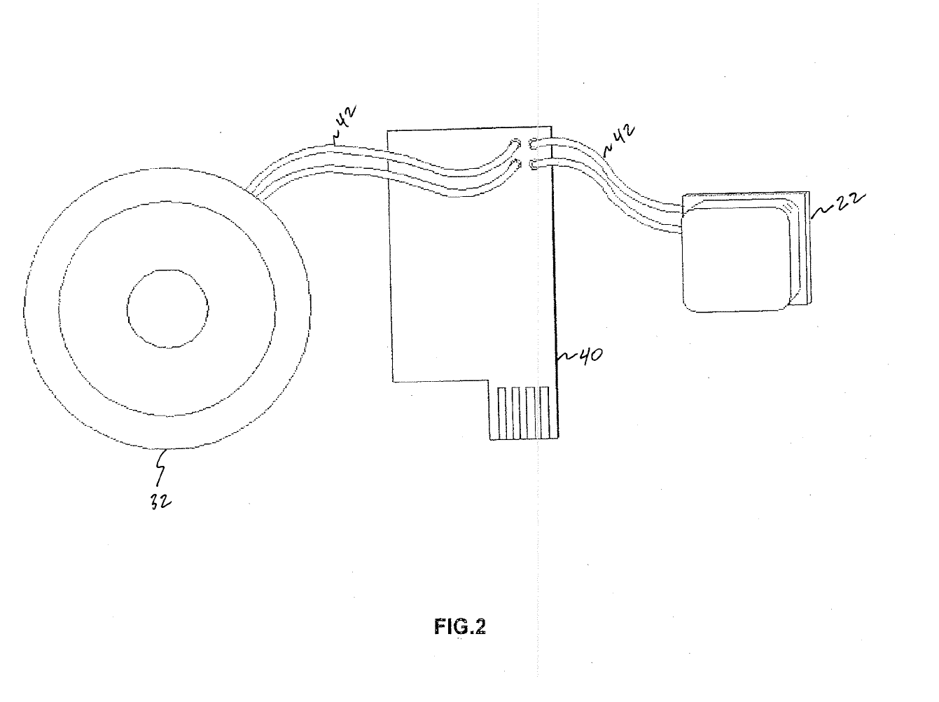

When placed on a store shelf for display, the carton 12 is oriented such that a primary side 14 of the carton faces in the direction of the consumer. The primary visible side of the carton includes a switch 22 operatively connected to electronic components configured to begin playing an audio message over a speaker 32. The electronic components may be housed on a printed circuit board 40, as best seen in FIG. 2. When the speaker is integrated into the box, a plurality of holes 30 are provided in the primary side of the carton to ensure the sound is visible. The carton further includes an instructional message to consumers 20 pointing to the switch 22 and directing the consumers to trigger the switch in order to hear the message stored within the electronic circuitry.

The switch 22 is illustrated as a button switch that can be pressed by a consumer to trigger the initiation of the audio playback. The switch is preferably oriented such that a consumer presses the switch in a direction going into the display carton. Any other form of switch may be used, including touch or pressure sensitive switches, toggle switches, or others. In some examples of the invention, the switch is illuminated by a light housed within the button cover, with power being provided by a battery housed within the carton. In yet other examples, the electronics include a motion sensor operatively configured to cause the audio playback when it detects motion in the vicinity of the carton. While the switch is illustrated as being housed in a manner that sandwiches it between layers of the carton, it may alternatively be attached to an exterior surface of the carton or otherwise configured to be associated with the carton.

The speaker is illustrated as being a single standard cone speaker. Ideally, the speaker will be relatively shallow so that it does not occupy more of the carton than necessary and thereby affect the overall volume of the carton or the volume available to be used by goods packaged for sale. As with the switch, the speaker is depicted as being mounted within the carton and hidden behind a plurality of holes that enable sound to travel through the carton. Alternatively, the speaker may be mounted outside the carton or inside the carton.

The sound device includes electronic circuitry containing stored audio messages, a power source, and wired or other connections to operatively couple the switch and the speaker to the other circuitry. As shown in FIG. 2, the circuitry is indicated as being provided on a printed circuit board that includes a flash memory (or other suitable memory storage device). Sophisticated versions of the invention may include microprocessors and further components to play complex audio files. Sound playback cards of the type illustrated in FIG. 2 are readily available and may optionally include additional components not expressly discussed. The power source preferably comprises one or more small button batteries as appropriate, and may optionally comprise a solar power collector (not shown) coupled to the electronic device.

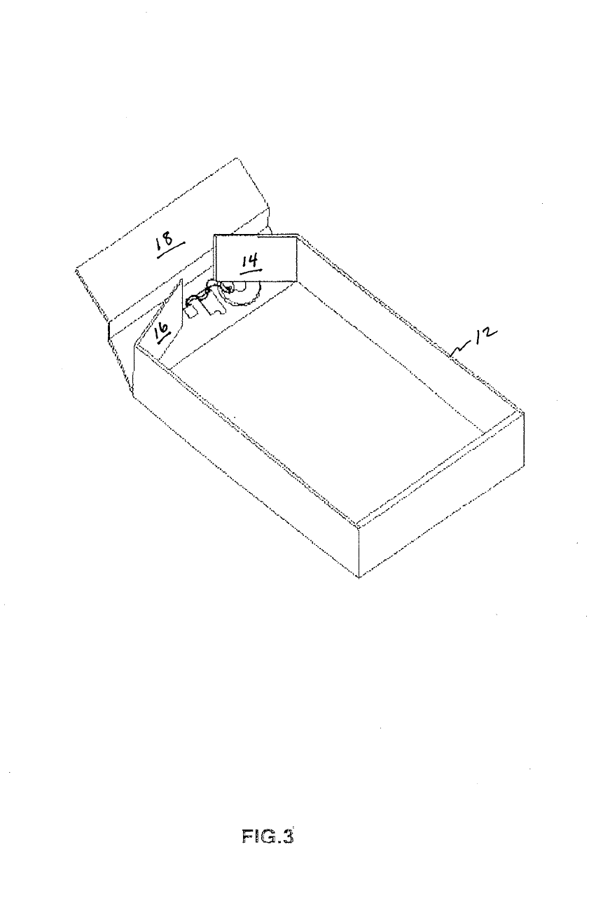

As best seen in FIG. 3, the sound components are all preferably sandwiched between layers of the material that form the carton. Thus, the speaker, switch, and circuitry are sandwiched between an exterior flap 18 and interior flaps 14, 16 that form the primary wall of the carton that is ultimately oriented toward the consumer. This arrangement protects all of the components and allows them to be securely mounted to the carton in a manner that uses very little space.

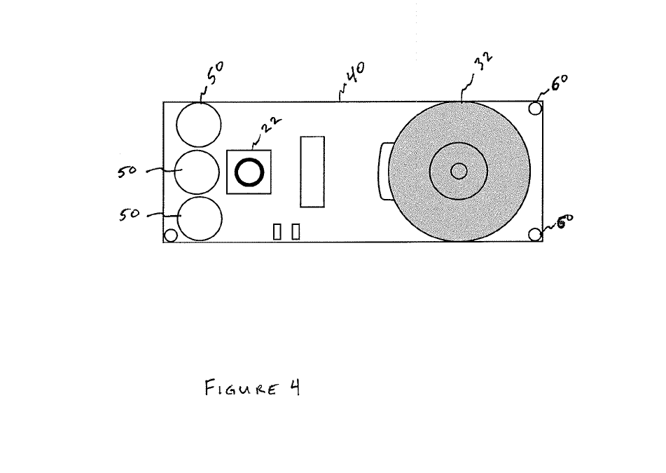

In the example of the invention as illustrated in FIGS. 2 and 3, the speaker and switch are depicted as being separate components operatively connected to the memory and other circuitry by wires 42. In an alternate form, as illustrated in FIG. 4, the speaker 32 and switch 22 may be secured directly to a printed circuit board 40. As shown, one or more batteries 50 are also mounted on the printed circuit board. In this example, three button-type batteries are indicated. The printed circuit board of FIG. 4 further includes one or more pegs 60, which may be used for alignment purposes and to facilitate accurate and secure attachment of the board 40 to the carton 12.

Although a printed circuit board is shown in the preferred embodiment, in an alternate example of the invention the electronic circuitry is printed directly onto a surface of the carton, with any necessary additional components (such as a battery or memory chip) mounted to the carton or otherwise operatively coupled to the printed circuitry. Likewise, the sound circuitry need not use a printed circuit board. In the particular embodiment using a touch sensitive switch and components printed onto the carton, the device is particularly thin and takes up little or no space on the carton.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A device for displaying a plurality of items, comprising:
a carton configured to hold the plurality of items;
a speaker attached to the carton;
a memory containing stored audio information related to the plurality of items, the memory being carried by the carton and further being operatively coupled to the speaker; and
a switch attached to the carton and operatively coupled to the memory, whereby the stored audio information is played through the speaker when the switch is activated by a user.

2. The device of claim 1, wherein the carton is formed from cardboard.

3. The device of claim 1, further comprising a power source configured to provide electrical power to operate the speaker.

4. The device of claim 3, wherein the power source comprises a battery.

5. The device of claim 1, wherein the carton comprises at least a portion of a container used to ship the plurality of items.

6. The device of claim 1, further comprising a printed circuit board.

7. The device of claim 1, further comprising circuitry printed onto a surface of the carton.

8. The device of claim 1, wherein a wall of the carton comprises a first layer and a second layer, and the speaker is mounted between the first layer and the second layer.

9. The device of claim 1, wherein a wall of the carton comprises a first layer and a second layer, and the switch is mounted between the first layer and the second layer.

10. The device of claim 1, wherein a wall of the carton comprises a first layer and a second layer, and the memory is mounted between the first layer and the second layer.

11. The device of claim 1, wherein stored audio information comprises an advertisement.

12. A device for displaying a plurality of items, comprising:
a container configured to hold the plurality of items;
a means for playing stored audio information related to the plurality of items; and
a switch attached to the container and operatively coupled to the means for playing stored audio information, whereby the stored audio information is played when the switch is activated by a user.

13. The device of claim 12, wherein the container is formed from cardboard.

14. The device of claim 12, further comprising a light configured to illuminate the switch.

15. The device of claim 1, wherein the plurality of items comprise consumables.

16. The device of claim 1, wherein the means for playing stored information comprises a printed circuit board.

17. The device of claim 1, wherein stored audio information comprises an advertisement.

18. The device of claim 12, further comprising a solar power source operatively coupled to provide power to the means for playing stored audio information.
